(19) United States
(12) Patent Application Publication
(10) Pub. No.: US 2019/0325504 A1
(43) Pub. Date: Oct. 24, 2019

(54) BROKERAGE SYSTEM AND METHOD FOR ORDERING PRODUCT

(71) Applicant: QUEENS SMILE Co., Ltd., Seoul (KR)

(72) Inventor: Ick Soo HAN, Seoul (KR)

(21) Appl. No.: 16/381,848

(22) Filed: Apr. 11, 2019

(30) Foreign Application Priority Data
Apr. 18, 2018 (KR) 10-2018-0044935

(51) Int. Cl. G06Q 30/06; G06Q 10/02

(52) U.S. Cl. CPC G06Q 30/0637; G06Q 30/0619; G06Q 50/12; G06Q 30/0641; G06Q 10/02

(57) ABSTRACT

According to an embodiment of the disclosure, a product order brokerage system comprises a customer terminal configured to receive entry of product purchase or reservation information, a plurality of product seller terminals configured to provide business days, break times, and kinds and quantities of products orderable per business time, and a product brokerage server configured to broker a purchase or reservation for each of the kinds and quantities of products, the break times, and the business days provided from the product seller terminals based on the entered product purchase or reservation information from the customer terminal.

### CROSS-REFERENCE TO RELATED APPLICATION(S)

This patent application claims priority under 35 U.S.C. § 119 to Korean Patent Application No. 10-2018-0044935 filed on Apr. 18, 2018, in the Korean Intellectual Property Office, the disclosure of which is incorporated by reference herein in its entirety.

### TECHNICAL FIELD

Embodiments of the disclosure relate to brokerage systems and methods for ordering products or goods.

### DESCRIPTION OF RELATED ART

As restaurant business flourishes and comes in a large size, management plays a critical role in running restaurants. A lack of systemized management especially in cooking and serving may result in a failure to live up to each customer and may lose customers' trust. Bigger restaurants may have difficulty in providing service suited for each customer.

An approach to address these issues is to adopt a reservation system in which customers are required to make a reservation before coming to the restaurant. However, conventional reservation systems may not properly serve customers when the restaurant is busy, e.g., during the lunch time.

Customers are not provided information about whether their order has been properly received or how longer they have to wait for food, ending up continuing to wait.

Therefore, a need rises for a product order brokerage system and method for brokering order of food or goods which are able to resolve such customer inconvenience.

### SUMMARY

According to an embodiment of the disclosure, a product order brokerage system comprises a customer terminal configured to receive entry of product purchase or reservation information, a plurality of product seller terminals configured to provide business days, break times, and kinds and quantities of products orderable per business time, and a product brokerage server configured to broker a purchase or reservation for each of the kinds and quantities of products, the break times, and the business days provided from the product seller terminals based on the entered product purchase or reservation information from the customer terminal.

The kinds of products may be classified into individual products and combo products of the individual products. The individual products may include cooked foods, manufactured products, handcrafted products, cultivated products, or butchered products.

The product brokerage server may be configured to reduce a purchase quantity of a sellable quantity within a business time corresponding to a purchase time when receiving a purchase order request message including the purchase time and the kinds and quantities of products from the customer terminal.

The product brokerage server may be configured to switch a purchase by a product purchaser within a particular time into a reserved purchase status when there is no orderable quantity within the particular time.

According to an embodiment of the disclosure, a product order brokerage method comprises providing business days, a break time per business day, and kinds and quantities of products orderable per business time from a product seller terminal, providing product sale information, provided from the product seller terminal, from a product brokerage server to a customer terminal, and brokering a purchase or reservation per time for the kinds and quantities of products orderable per business time based on product order information entered through the customer terminal.

Brokering the purchase or reservation may include updating the orderable quantity by reducing a purchase quantity of a sellable quantity within a business time corresponding to a purchase time when the product brokerage server receives a purchase order request message including the purchase time and the kinds and quantities of products from the customer terminal.

Brokering the purchase or reservation may include switching a purchase by a product purchaser within a particular time into a reserved purchase status when there is no orderable quantity in a store designated by the product purchaser within the particular time.

The disclosure is not limited to the foregoing objects, and other unmentioned objects will be apparent to one of ordinary skill in the art from the following description.

Thus, according to the embodiments of the disclosure, a product purchaser may be allowed to purchase depending on the orderable quantity per business time based on the product sale capacity set by the product seller and, thus, the purchaser is allowed to receive the product that he purchased immediately when visiting the store. This way may provide a higher satisfaction to visiting customers.

According to the embodiments of the disclosure, when the product is a food, the food supplier may calculate the quantity of supply depending on the food supply capacity and provide the food purchaser with food at the exact timing and with a reduced burden of deploying personnel and inventories, thereby providing a high quality of service.

According to the embodiments of the disclosure, when there is no orderable quantity of products per business time, purchase is restricted and the next orderable time and an orderable quantity are displayed. Thus, the product purchaser may be allowed to receive the product previously purchased immediately when arriving at the store.

### BRIEF DESCRIPTION OF THE DRAWINGS

A more complete appreciation of the disclosure and many of the attendant aspects thereof will be readily obtained as the same becomes better understood by reference to the following detailed description when considered in connection with the accompanying drawings, wherein:

FIG. 1 is a block diagram illustrating a product order brokerage system according to an embodiment of the disclosure;

FIG. 2 is a block diagram illustrating a configuration of a product brokerage server in a product order brokerage system as shown in FIG. 1, according to an embodiment of the disclosure;

FIG. 3 is a view illustrating an example customer platform according to an embodiment of the disclosure;

FIG. 4 is a flowchart illustrating a brokerage method for ordering a product according to an embodiment of the disclosure;

FIG. 5 is a view illustrating an example execution screen of selection of a menu item on a platform as shown in FIG. 4, according to an embodiment of the disclosure;

FIG. 6 is a view illustrating an example chatting platform according to an embodiment of the disclosure; and

FIG. 7 is a view illustrating an example computing environment according to an embodiment of the disclosure.

### DETAILED DESCRIPTION OF EXEMPLARY EMBODIMENTS

Hereinafter, embodiments of the disclosure are described with reference to the accompanying drawings. However, it should be appreciated that the disclosure is not limited to the embodiments, and all changes and/or equivalents or replacements thereto also belong to the scope of the disclosure. The same or similar reference denotations may be used to refer to the same or similar elements throughout the specification and the drawings. As used herein, the terms “have,” “may have,” “include,” or “may include” a feature (e.g., a number, function, operation, or a component such as a part) indicate the existence of the feature and do not exclude the existence of other features.

As used herein, the terms “A or B,” “at least one of A and/or B,” or “one or more of A and/or B” may include all possible combinations of A and B. For example, “A or B,” “at least one of A and B,” “at least one of A or B” may indicate all of (1) including at least one A, (2) including at least one B, or (3) including at least one A and at least one B.

As used herein, the terms “first” and “second” may modify various components regardless of importance and/or order and are used to distinguish a component from another without limiting the components. For example, a first user device and a second user device may indicate different user devices from each other regardless of the order or importance of the devices. For example, a first component may be denoted a second component, and vice versa without departing from the scope of the disclosure.

It will be understood that when an element (e.g., a first element) is referred to as being (operatively or communicatively) “coupled with/to,” or “connected with/to” another element (e.g., a second element), it can be coupled or connected with/to the other element directly or via a third element. In contrast, it will be understood that when an element (e.g., a first element) is referred to as being “directly coupled with/to” or “directly connected with/to” another element (e.g., a second element), no other element (e.g., a third element) intervenes between the element and the other element.

As used herein, the terms “configured (or set) to” may be interchangeably used with the terms “suitable for,” “having the capacity to,” “designed to,” “adapted to,” “made to,” or “capable of” depending on circumstances. The term “configured (or set) to” does not essentially mean “specifically designed in hardware to.” Rather, the term “configured to” may mean that a device can perform an operation together with another device or parts.

For example, the term “processor configured (or set) to perform A, B, and C” may mean a generic-purpose processor (e.g., a CPU or application processor) that may perform the operations by executing one or more software programs stored in a memory device or a dedicated processor (e.g., an embedded processor) for performing the operations.

The terms as used herein are provided merely to describe some embodiments thereof, but not to limit the scope of other embodiments of the disclosure. As used herein, the singular forms “a,” “an,” and “the” are intended to include the plural forms as well, unless the context clearly indicates otherwise. Unless otherwise defined, all terms including technical and scientific terms used herein have the same meaning as commonly understood by one of ordinary skill in the art to which the embodiments of the disclosure belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein. In some cases, the terms defined herein may be interpreted to exclude embodiments of the disclosure.

A product order brokerage system and method, according to various embodiments of the disclosure, are described below in detail with reference to the accompanying drawings.

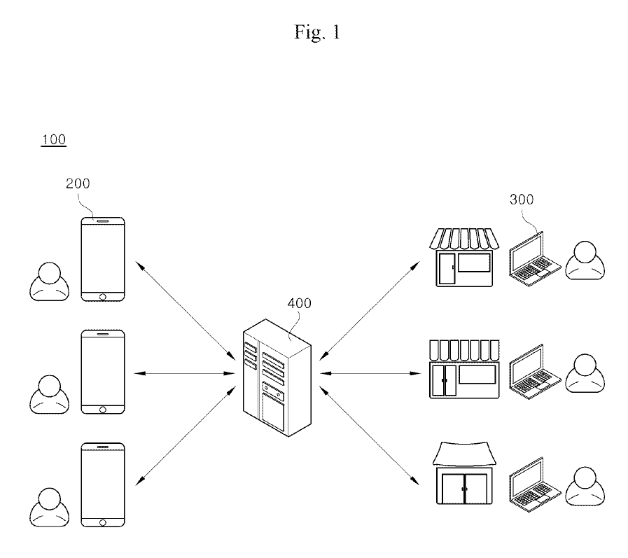

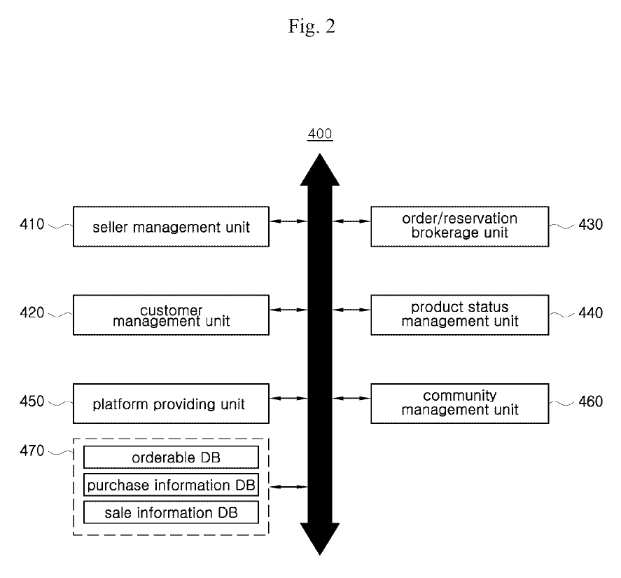

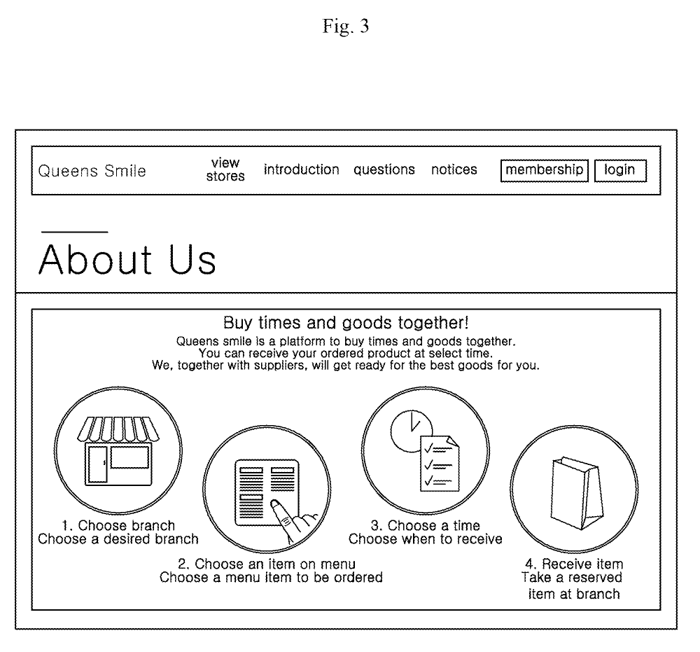

FIG. 1 is a block diagram illustrating a product order brokerage system according to an embodiment of the disclosure. FIG. 2 is a block diagram illustrating a configuration of a product brokerage server in a product order brokerage system as shown in FIG. 1, according to an embodiment of the disclosure. FIG. 3 is a view illustrating an example customer platform according to an embodiment of the disclosure.

Referring to FIG. 1, according to an embodiment of the disclosure, a product order brokerage system 100 may include a customer terminal 200, a product seller terminal 300, and a product brokerage server 400.

The customer terminal 200 may be a terminal for entering purchase/reservation information about a product to be ordered or purchased.

The customer terminal 200 may access or connect to the product brokerage server 400 through a customer platform and, thereby, may identify location information about the store, business days and break times of the store, and the kind, number, and price of products orderable per business hour and order a product.

The kind of products may be classified into individual products and combo products of individual products. Each individual product may be any one of cooked foods, manufactured products, handicrafts, cultivated products, or butchered products.

For example, where the product is a food, a platform for food customers may include a display processing function of displaying, e.g., geographical information about restaurants selling the food, take-in/out information, where to pick up the food, number of tables, and whether a parking lot is available, a menu processing function for management to provide menu information about foods and to allow the customer to order a selected dish, a reservation processing function for selecting a dish and the quantity depending on the orderable number for each dish per time, a notification function of giving a notification when a reference time for picking up the dish arrives, and a setting function for setting up a customer application.

The menu processing function provides management to provide information about dishes on sale through food sale and to allow the customer to order a dish that he/she chooses.

For example, when a customer orders a dish that he/she chooses, the menu processing function provides information about whether it is orderable as determined based on the orderable quantity for each dish per time, the price determined as per whether it is orderable, the quantity ordered, the total price of order, discounted price, and history-of-order information.

The reservation processing function allows a dish and the quantity to be chosen depending on whether it is orderable as determined based on the orderable quantity for each dish per time.

The product seller terminal 300 may be a terminal that is placed in a store to provide product information, such as business days, break times and per-business time orderable kinds of products, and the quantity of sale.

The product seller terminal 300 may be a terminal for cashier or a terminal for kitchen. The terminal for cashier may be a terminal that displays product order information and customer information. The terminal for kitchen may be a terminal that displays the kind of products to sell per time and quantity information.

A platform for product seller may be installed on the product seller terminal 300.

The platform for product seller may include a revenue information processing function to allow the product seller to manage his/her revenue status information, an inventory status processing function to manage an inventory status (e.g., a food material status if the product is a food) for products that the seller is selling, a sale capacity/customer satisfaction assessing function to real-time assess the actual order processing capacity and the customer satisfaction, and a setting function to set up the platform for product seller.

The revenue information processing function allows the food seller to manage information about the revenue status.

The sale capacity/customer satisfaction function may obtain information necessary to enhance sale and customers' preferred menu items (e.g., dishes) by analyzing and assessing the customers' satisfaction during the course of selling dishes actually ordered.

For example, the revenue information processing function enables management of daily revenue information (i.e., month/date, quantity ordered, amount, total amount, expenditure, net profit, and per-store ranking information), per-period revenue information (i.e., the revenue during the seller's desired period, expenditure, net profit, and earning rate information), and real-time revenue information.

The product seller terminal 300 may access the product brokerage server 100 via the platform for product seller.

The product seller terminal 300 sets up the capacity of product supply per business time and provides the capacity of product supply to the product brokerage server 400. The product brokerage server 400 may provide the quantity orderable per business time to the customer terminal 200 based on the product supply capacity set by the product seller.

For example, where the product seller is a hamburger seller, the product seller terminal 300 provides the indication or the information that “it takes five minutes to process one handcrafted hamburger,” as the food supply capacity of hamburger restaurant A, to the product brokerage server 400.

Thus, the product brokerage server 400 may determine that hamburger restaurant A may make 10 handcrafted hamburgers for 60 minutes and set and provide 10, as the number of handcrafted hamburgers orderable per time.

The product brokerage server 400 may perform brokerage to purchase and reserve per time for the quantity and kind of products orderable per business time and break times, and business days provided from the product seller terminal based on information (order/purchase information) entered through the customer terminal 200.

For example, the product brokerage server 400 may include a seller management unit 410, a customer management unit 420, an order/reservation brokerage unit 430, a product status management unit 440, a platform providing unit 450, a community management unit 460, and a database 470.

The seller management unit 410 performs the function of managing, per business entity depending on the kind of products, the business days, break times, and per-business time orderable kinds of products provided from the product seller terminal.

The seller management unit 410 performs the function of managing, per business entity, additional information about business entities (e.g., the locations of the stores, number of tables, service satisfaction, available kitchen staff, serving staff, parking lot or no, and playroom or no) from the product seller terminal 300.

The seller management unit 410 includes the function of managing daily revenue information (i.e., month/date, quantity ordered, amount, total amount, expenditure, net profit, and per-store ranking information), per-period revenue information (i.e., the revenue during the seller's desired period, expenditure, net profit, and earning rate information), and real-time revenue information, according to buyers' purchase.

The seller management unit 410 may also provide an analysis on the actual food cooking time of the seller, customers' preferred dishes, and information for enhancing sale.

The seller management unit 410 may compare and manage revenue information about each product seller in the same business sector depending on the business type of each product seller and may include the function of providing a seller management terminal with comparison information by which the product seller may compare his own revenue with the revenues of other product sellers in the same business sector.

The customer management unit 420 performs the function of managing, per purchaser, order/reservation information about the product that the customer terminal 200 intends to buy.

The customer management unit 420 may include the functions of managing information about purchasers (the number of purchasers) who have purchased or ordered per period, per product, or per amount depending on the store and providing the managed purchaser information to the purchaser terminal that intends to purchase or order a product in the store. As used herein, the term “purchaser terminal” may be interchangeably used with the term “customer terminal.”

The order/reservation brokerage unit 430 may broker the order of purchase of the product based on the product order information requested by the customer terminal.

The order/reservation brokerage unit 430 may compare the quantity of products ordered by the purchaser in the store with the quantity orderable per business time in the store and provide the purchaser terminal with information about whether the desired quantity is orderable, the price of order as determined depending on whether it is orderable, the quantity ordered, the total price of order, discounted price, and order history information.

The order/reservation brokerage unit 430 may compare the quantity ordered in the store designated by the customer with the sellable quantity per business time in the store and, when there are no products or less than a predetermined number of products orderable in the business time, switch the purchaser's order into a reserved purchase, calculate the wait time to the next orderable time, and provide the wait time to the customer terminal 200.

The product status management unit 440 performs the function of adjusting (or reducing) the per-business time orderable quantity registered per seller based on the ordered quantity.

For a particular product (e.g., food), the product status management unit 440 may register limited products that may be associated with a particular product selling within a limited period in the seller store and, when the particular product is ordered, provide the limited product in association.

When the quantity ordered by the customer per business time is larger than the quantity sellable on the seller terminal, the product status management unit 440 may provide the seller terminal with a message to “request to increase per-hour sale quantity.”

The product seller may indirectly obtain a help necessary to raise the per-business time revenue by receiving the message.

The product status management unit 440 may real-time receive and update the variable per-business time orderable quantity which is provided form the seller terminal.

The platform providing unit 450 functions to provide a platform for product customers and a platform for product sellers.

Each platform may include, e.g., an application, a program, or a webpage installed or driven on the customer terminal 200 or the product seller terminal 300.

Here, the web browser may be a program or application that enables use of world wide web (WWW) services or that receives and shows hyper text written in the hyper text mark-up language (HTML), and the web browser may include, e.g., Netscape, Explorer, or Chrome. The term “application” may mean an application executed on the terminal, and the application may include, e.g., an app running on a mobile terminal, e.g., a smartphone. The app may be downloaded and installed from an application market which is a virtual market where mobile contents may freely be sold or bought.

The community management unit 460 functions to record, store, and manage evaluations, reviews, and conversations between customers, between customer and seller, and between sellers.

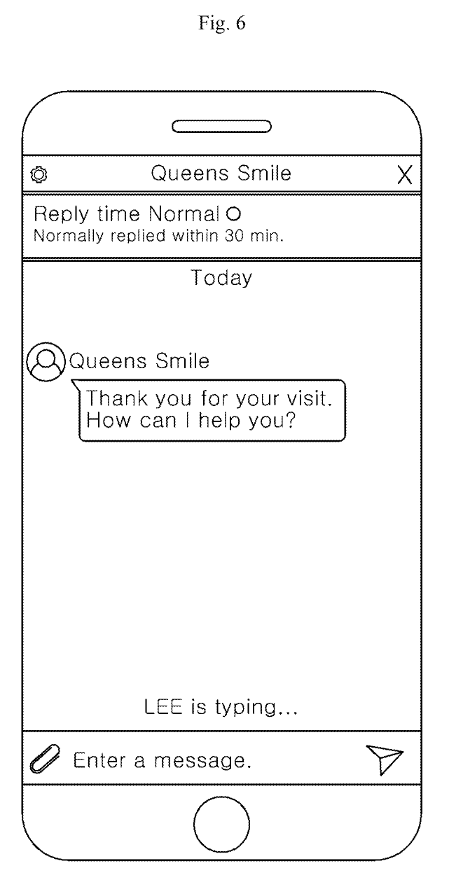

Referring to FIG. 6, the community management unit 460 may interwork with in chatting platforms in the platform for sellers and the platform for customers. The chatting platform may provide the function of retrieving particular contents, a ‘like’ button such as the one provided in Facebook, a social media plug-in function, and the functions of interworking with Naver blogs, Facebook, Twitter, and RSS feed.

The database 470 may include an orderable information database (DB), a purchase information DB, and a sale information DB.

The orderable information DB stores orderable information about each menu item per time.

The orderable information may include, e.g., an orderable quantity and per-orderable menu item images, assessment information, and total amount of order.

The orderable quantity stored in the orderable information DB may automatically be updated whenever menu items and a quantity of menu items are purchased by the user for a particular time.

The purchase information DB stores per-purchaser purchase information.

For example, the purchase information DB stores the kind of product and order quantity information per time by the purchaser.

The per-purchaser purchase information stored in the purchase information DB may be used in producing daily revenue information per product seller or in identifying what kind of products have been purchased a lot within what time period.

The sale information DB 453 stores per-seller product sellable information. When the product is a food, the per-seller product sellable information may include, e.g., a cooking time per food, cooking personnel, and whether additional cooking personnel are required.

The product sellable information stored in the sale information DB 453 may be used in calculating the per-product orderable quantity stored in the orderable information DB 451.

The database may include fields or elements to be implemented to be suited for the purpose of the disclosure using a relational database management system (RDBMS), such as Oracle, MYSQL, MSSQL, Infomix, Sybase, or DB2, an object-oriented database management system (OODBMS), such as Gemston, Orion, or O2, and an XML native database, such as Excelon, Tamino, or Sekaiju. Each field or element may be formed of a superordinate concept, or subordinate concept, or field or element.

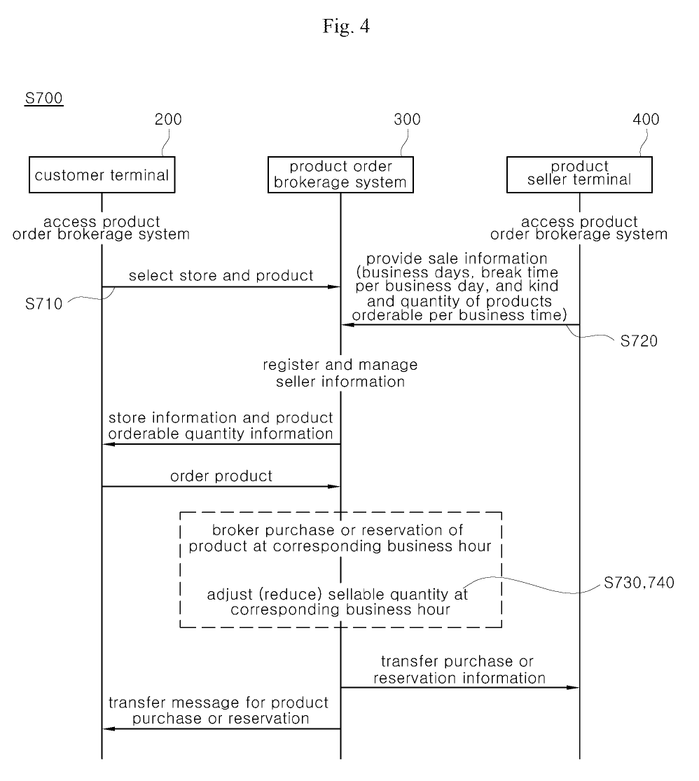

FIG. 4 is a flowchart illustrating a brokerage method for ordering a product according to an embodiment of the disclosure.

Referring to FIG. 4, according to an embodiment of the disclosure, in a product order brokerage method S700, when store/product search information to order a product within a particular time period from a customer terminal is entered (S710), the product brokerage server 400 provides sale information about the seller or store corresponding to the search information (S710).

The sale information may include location information about the product seller or store, business days and break times of the seller or store, and information about the kind, quantity, and price of products orderable per business time.

When the process of purchasing the product on the customer terminal 200 is complete, the product brokerage server 400 updates the per-business time sellable quantity for the seller or store corresponding to the time of purchase (S730).

When the orderable quantity of products desired to be purchased on the customer terminal 200 within a particular time period is not there or is smaller than the quantity to be ordered by the customer, the product brokerage server 400 provides a message to restrict the order by the purchaser or switches the order into a reserved purchase status (S740).

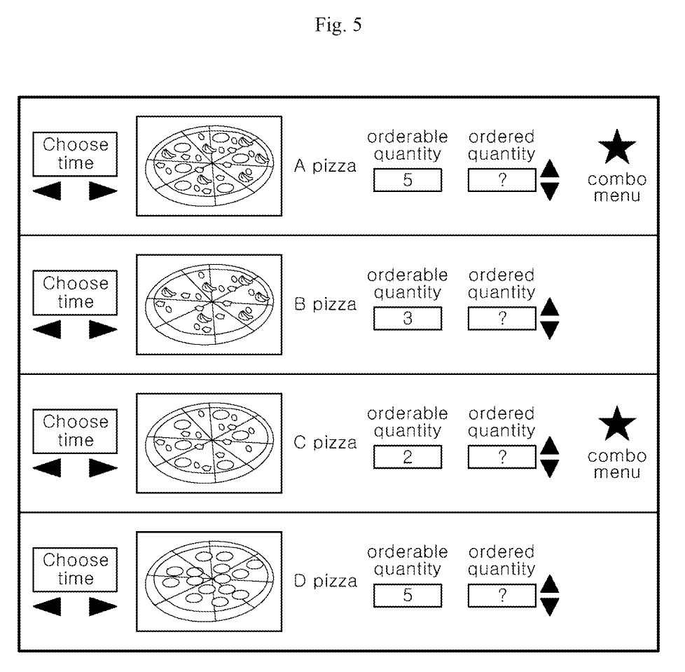

FIG. 5 is a view illustrating an example execution screen of selection of a menu item on a platform as shown in FIG. 4, according to an embodiment of the disclosure.

Referring to FIG. 5, when the product ordered is a food, the product brokerage server 400 determines and provides an orderable quantity for each menu item per time based on the food supply capacity (e.g., cooking time per food and per-time cooking personnel information) set by the food seller.

The customer terminal 200 may access the product brokerage server 400 via the platform for sellers, identify the quantity orderable for each menu item per time, and order and purchase food.

For example, the customer terminal 200 may select and purchase a quantity of food using the “▴” button.

For example, the customer terminal 200 may select the 11:00 to 11:59 period by pressing the “ [symbol] ” button or the “ [symbol] ” button to select a certain time period and then identify the quantity orderable for each menu item during the 11:00 to 11:59 period, and the customer terminal 200 may select and purchase a quantity of food using the “▴” button to order a handcrafted hamburger and French potatoes.

When accessing the product brokerage server 400 via the platform for customers to identify a quantity orderable for each menu item per time and purchase food, the customer terminal 200 may refer to per-menu item images, evaluation information, and total quantity-of-order information when ordering the menu item.

When there are the orderable quantity of food within the particular time based on the orderable quantity for each menu item per time, the product brokerage server 400 permits the purchaser to buy the food. To that end, when there are the orderable quantity of food within the particular time, the product brokerage server 400 activates the “▴” button for ordering to be shown and, when the “▴” button is pressed, allows the quantity to increase.

In this case, while the “▴” button is pressed to increase the quantity orderable for the menu item, the product brokerage server 400 may compare the increasing quantity with the orderable quantity and allows the increase to be performed only until the increasing quantity becomes equal to the orderable quantity.

When there are no orderable quantity of food within the particular time based on the orderable quantity for each menu item per time, the product brokerage server 400 restricts purchase by the purchaser.

To that end, when there are no orderable quantity of food within the particular time, the product brokerage server 400 deactivates the “▴” button for ordering to be hidden or, although the “▴” button is pressed, prevents the quantity from increasing.

Thus, when there are no orderable quantity of food within the particular time, the product brokerage server 400 switches purchase by the food purchaser within the particular time into a reserved purchase and calculates and provides a wait time for the food purchaser.

For example, the product brokerage server 400 may determine, as the wait time, the time gap between the next orderable time and the particular time selected by the food purchaser and provide the wait time to the purchaser.

Thus, according to the embodiments of the disclosure, a product purchaser may be allowed to purchase depending on the orderable quantity per business time based on the product sale capacity set by the product seller and, thus, the purchaser is allowed to receive the product that he purchased immediately when visiting the store. This way may provide a higher satisfaction to visiting customers.

According to the embodiments of the disclosure, when the product is a food, the food supplier may calculate the quantity of supply depending on the food supply capacity and provide the food purchaser with food at the exact timing and with a reduced burden of deploying personnel and inventories, thereby providing a high quality of service.

According to the embodiments of the disclosure, when there is no orderable quantity of products per business time, purchase is restricted and the next orderable time and an orderable quantity are displayed. Thus, the product purchaser may be allowed to receive the product previously purchased immediately when arriving at the store.

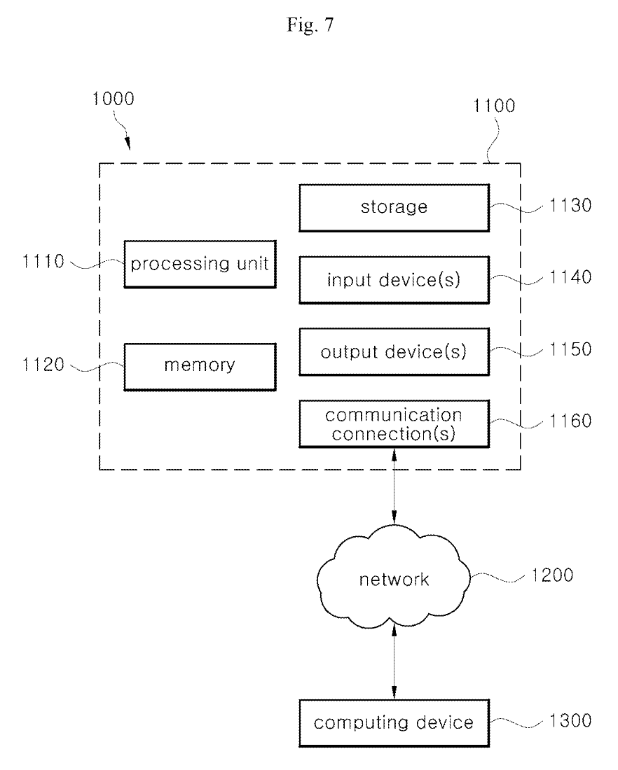

FIG. 7 is a view illustrating an example computing environment where an embodiment of the disclosure may be implemented. FIG. 7 illustrates a system 1000 including a computing device 1100 configured to implement the above-described embodiments. For example, the computing device 1100 may include, but is not limited to, a personal computer, a server computer, a handheld or laptop device, a mobile device (e.g., a mobile phone, a personal digital assistant (PDA), or a media player), a multi-processor system, a customer electronic device, a micro computer, a main frame computer, or a distributed computing environment including any one of the above-described systems or devices.

The computing device 1100 may include at least one processing unit 1110 and at least one memory 1120. The processing unit 1110 may include, e.g., a central processing unit (CPU), a graphic processing unit (GPU), a microprocessor, an application specific integrated circuit (ASIC), or field programmable gate arrays (FPGA). The processing unit 1110 may have a plurality of cores. The memory 1120 may be a volatile memory (e.g., a random access memory (RAM), a non-volatile memory (e.g., a read-only memory (ROM) or flash memory), or a combination thereof. The computing device 1100 may include additional storage 1130. The storage 1130 includes, but is not limited to, magnetic storage or optical storage. The storage 1130 may store computer-readable commands (or instructions) to implement one or more embodiments as described above and may further store other computer-readable commands (or instructions) to implement an operating system (OS) or application programs. The computer-readable commands (or instructions) stored in the storage 1130 may be loaded onto the memory 1120 to be executed by the processing unit 1110. The computing device 1100 may include at least one input device 1140 and at least one output device 1150.

The input devices 1140 may include, e.g., a keyboard, a mouse, a pen, a voice input device, a touch input device, an infrared (IR) camera, a video input device, or any other various input devices. The output devices 1150 may include, e.g., one or more displays, speakers, printers, or any other output devices. The computing device 1100 may use an input device or output device provided in another computing device as the input device 1140 or the output device 1150.

The computing device 1100 may include at least one communication connection 1160 to enable the computing device 1100 to communicate with other devices (e.g., the computing device 1300).

The communication connections 1160 may include a modem, a network interface card (NIC), an integrated network interface, a radio frequency transmitter/receiver, an IR port, a universal serial bus (USB) connection, or other interfaces to connect the computing device 1100 with other computing devices. The communication connections 1160 may include wired connections or wireless connections. The above-described components of the computing device 1100 may be connected by various interconnects (e.g., peripheral component interconnect (PCI), USB, firmware (IEEE1394), or optical bus architecture), such as a bus, and may be interconnected by the network 1200. As used herein, the terms “component” and “system” may generally denote hardware, a combination of hardware and software, software, or computer-related entities which are software in execution.

For example, the components may be processes, processors, objects, executable articles, execution threads, programs, and/or computers, but not limited thereto. For example, applications running on a controller and the controller may be the components. One or more components may be present inside a process and/or execution thread, and the components may be localized on one computer or distributed between two or more computers.

Although specific embodiments of the disclosure have been described above, various changes may be made thereto without departing from the scope of the disclosure. Thus, the scope of the disclosure should not be limited to the above-described embodiments, and should rather be defined by the following claims and equivalents thereof. As such, it should be appreciated that although the disclosure has been shown and described in connection with a limited number of embodiments thereof, various changes in form or detail may be made thereto by those skilled in the art.

Thus, the spirit of the disclosure should be grasped only by the appended claims, and all equivalents or modifications thereto belong to the category of the spirit of the disclosure.

What is claimed is:

1. A product order brokerage system, comprising:
a customer terminal configured to receive entry of product purchase or reservation information;
a plurality of product seller terminals configured to provide business days, break times, and kinds and quantities of products orderable per business time; and
a product brokerage server configured to broker a purchase or reservation for each of the kinds and quantities of products, the break times, and the business days provided from the product seller terminals based on the entered product purchase or reservation information from the customer terminal.

2. The product order brokerage system of claim 1, wherein the kinds of products are classified into individual products and combo products of the individual products, and wherein the individual products include cooked foods, manufactured products, handcrafted products, cultivated products, or butchered products.

3. The product order brokerage system of claim 1, wherein the product brokerage server is configured to reduce a purchase quantity of a sellable quantity within a business time corresponding to a purchase time when receiving a purchase order request message including the purchase time and the kinds and quantities of products from the customer terminal.

4. The product order brokerage system of claim 3, wherein the product brokerage server is configured to switch a purchase by a product purchaser within a particular time into a reserved purchase status when there is no orderable quantity within the particular time.

5. A product order brokerage method, comprising:
providing business days, a break time per business day, and kinds and quantities of products orderable per business time from a product seller terminal;
providing product sale information, provided from the product seller terminal, from a product brokerage server to a customer terminal; and
brokering a purchase or reservation per time for the kinds and quantities of products orderable per business time based on product order information entered through the customer terminal.

6. The product order brokerage method of claim 5, wherein brokering the purchase or reservation includes updating the orderable quantity by reducing a purchase quantity of a sellable quantity within a business time corresponding to a purchase time when the product brokerage server receives a purchase order request message including the purchase time and the kinds and quantities of products from the customer terminal.

7. The product order brokerage method of claim 5, wherein brokering the purchase or reservation includes switching a purchase by a product purchaser within a particular time into a reserved purchase status when there is no orderable quantity in a store designated by the product purchaser within the particular time.

8. The product order brokerage method of claim 5, wherein the kinds of products are classified into individual products and combo products of the individual products, and wherein the individual products include cooked foods, manufactured products, handcrafted products, cultivated products, or butchered products.
